(19) United States
(12) Patent Application Publication
(10) Pub. No.: US 2024/0318795 A1
(43) Pub. Date: Sep. 26, 2024

(54) MODULAR LIGHT ARRANGEMENT

(71) Applicant: Light Science Technologies Limited, Derbyshire (GB)

(72) Inventors: Lucy CLARK, Derbyshire (GB); Craig PRICE, Derbyshire (GB)

(21) Appl. No.: 18/259,245

(22) PCT Filed: Dec. 24, 2021
(86) PCT No.: PCT/GB2021/000147

§ 371 Date: Jun. 23, 2023

(30) Foreign Application Priority Data
Dec. 24, 2020 (GB) 2020595.1

(51) Int. Cl. F21S 2/00; A01G 7/04; F21S 4/28; F21V 19/00

(52) U.S. Cl. CPC F21S 2/005; A01G 7/045; F21S 4/28; F21V 19/003

(57) ABSTRACT

The current disclosure discloses a modular light arrangement for a Controlled Environment Agriculture (CEA) system and a method of assembling thereof. It further discloses a method of servicing a light installation of such modular light arrangements. The modular light arrangement comprises a structural carrier having a bottom face with a first PCB mounting arrangement, a first side face with a second PCB mounting arrangement and a second side face with a third PCB mounting arrangement. The modular light arrangement further comprises a PCB having at least one light emitter. The PCB is removably mounted to one of the bottom face, the first side face and the second side face. An at least partially translucent cover is coupled to the structural carrier.

### CROSS REFERENCE TO RELATED APPLICATIONS

The present application is a US National Phase entry of PCT/GB2021/000147 filed Dec. 24, 2021, which claims priority to Great Britain Application No. 2020595.1 filed Dec. 24, 2020, the entirety of which are incorporated herein by reference.

### FIELD OF THE DISCLOSURE

The present disclosure relates to Controlled Environment Agriculture (CEA) and more specifically to a modular light arrangement for such an environment.

### BACKGROUND

Controlled Environment Agriculture (CEA) is a form of intensive farming where certain parameters affecting plant growth are closely monitored and or managed to optimise yield and/or revenue. Typical CEA environments are for example vertical farms, glasshouses and polytunnels. Although efforts have been made in the field of CEA, current systems still have many shortcomings holding back yield and/or revenue optimization. One of the challenges facing CEA is the intensive need for artificial lighting. The light installations can be complex and tend to be major contributor to installation and operating costs. There is a need for a lighting arrangement that provides a more flexible solution, lowers overall system cost, offers environmental benefits and provides a better way to maintain, service, repair, upgrade, refurbish at least some of the components.

The components and systems currently in use have multiple disadvantages associated with them and the current disclosure is aimed at overcoming at least some of these disadvantages.

### SUMMARY

It is desirable to provide an improved light arrangement suitable for a CEA system.

According to a first aspect there is provided a modular light arrangement for a Controlled Environment Agriculture (CEA) system. The modular light arrangement comprises a structural carrier having a bottom face with a first PCB mounting arrangement, a first side face with a second PCB mounting arrangement and a second side face with a third PCB mounting arrangement. The modular light arrangement further comprises a PCB having at least one light emitter. The PCB is removably mounted to one of the bottom face, the first side face and the second side face. An at least partially translucent cover is coupled to the structural carrier.

In a further aspect of the disclosure there is provided a method of assembling a modular light arrangement. The modular light arrangement comprises a structural carrier having a bottom face with a first PCB mounting arrangement, a first side face with a second PCB mounting arrangement and a second side face with a third PCB mounting arrangement. The modular light arrangement further comprises at least one PCB having at least one light emitter, with the at least one PCB being removably mounted to one of the first, second and third PCB mounting arrangements. An at least partially translucent cover is coupled to the structural carrier. The method comprises the step of mounting the at least one PCB to at least one of the bottom face, the first side face and the second side face of the structural carrier. The method further comprises the step of longitudinally inserting the structural carrier with the at least one PCB into the cover thereby slideably coupling the structural carrier to the cover. The method further comprises the step of fitting one or more end caps to the longitudinal ends of the modular light assembly to substantially close off the modular light arrangement.

In a further aspect of the disclosure there is provided a method of servicing a plurality of modular light arrangements. The method comprises the steps of providing a first batch of pre-assembled modular light arrangements and removing a second batch of modular light arrangements from a light installation and replacing them with the first batch. The method further comprises the steps of treating the second batch of modular light arrangements and removing a third batch of modular light arrangements from a light installation and replacing them with the second batch.

### BRIEF DESCRIPTION OF THE DRAWINGS

Embodiments will now be described by way of example only, with reference to the Figures, in which:

FIG. 1 is a diagrammatic representation of a modular light arrangement in accordance with the current disclosure;

FIG. 2 is an exploded view of one configuration of the modular light arrangement of FIG. 1;

FIG. 3 is an exploded view of another configuration of the modular light arrangement of FIG. 1;

FIG. 4 is an isometric representation of a cover used in the modular light arrangement of FIG. 1;

FIG. 5 is a diagrammatic end view of the cover of FIG. 4;

FIG. 6 is an isometric representation of a structural carrier used in the modular light arrangement of FIG. 1;

FIG. 7. is a diagrammatic end view of the structural carrier of FIG. 6;

FIG. 8 is a diagrammatic end view of an open end of an assembled modular light arrangement configured as in FIG. 2;

FIG. 9 is a diagrammatic end view of an open end of an assembled modular light arrangement configured as in FIG. 3;

FIG. 10. is an exploded view of an end cap arrangement suitable for the modular light arrangement of FIG. 1;

FIG. 11 is an isometric view of one portion of the end cap arrangement of FIG. 10;

FIG. 12 is an isometric view of another portion of the end cap arrangement of FIG. 10;

FIG. 13 is an isometric view of the assembled end cap arrangement of FIG. 10;

FIG. 14 is a diagrammatic representation of a low powered PCB for the modular light arrangement of FIG. 1;

FIG. 15 is a diagrammatic representation of a medium powered PCB for the modular light arrangement of FIG. 1;

FIG. 16 is a diagrammatic representation of a high powered PCB for the modular light arrangement of FIG. 1;

FIG. 17 is a flow chart representing methods of assembling and/or servicing one or more of the modular light arrangements of FIG. 1.

### DETAILED DESCRIPTION

Aspects and embodiments of the present disclosure will now be discussed with reference to the accompanying figures. Further aspects and embodiments will be apparent to those skilled in the art.

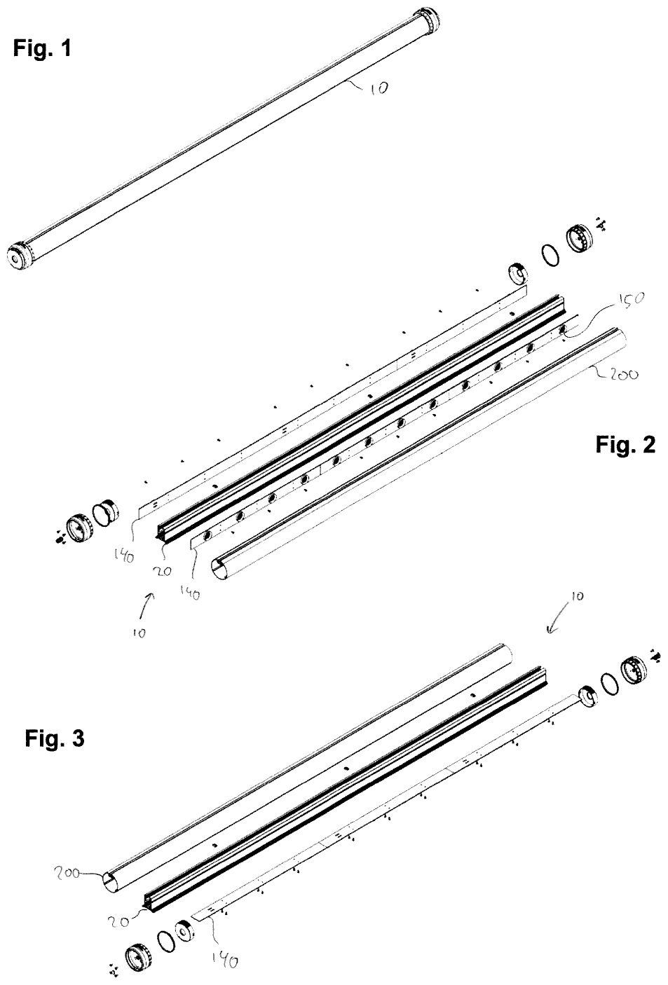

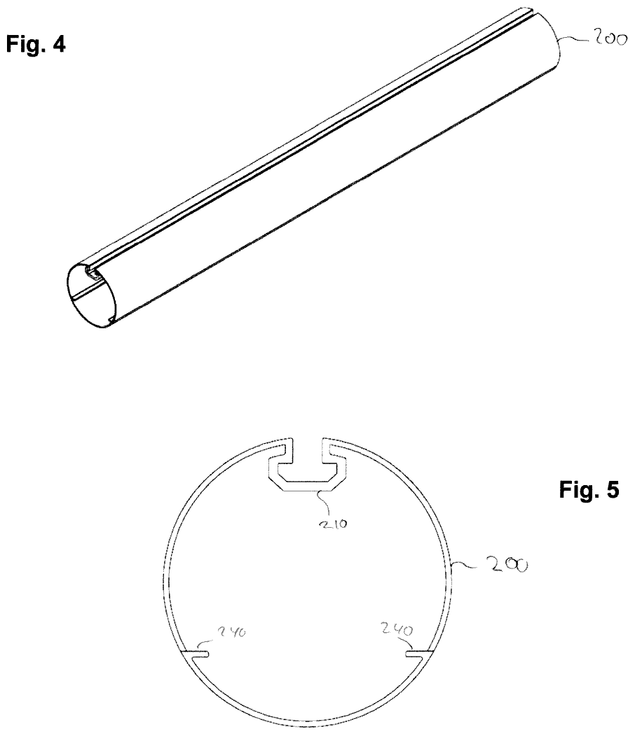

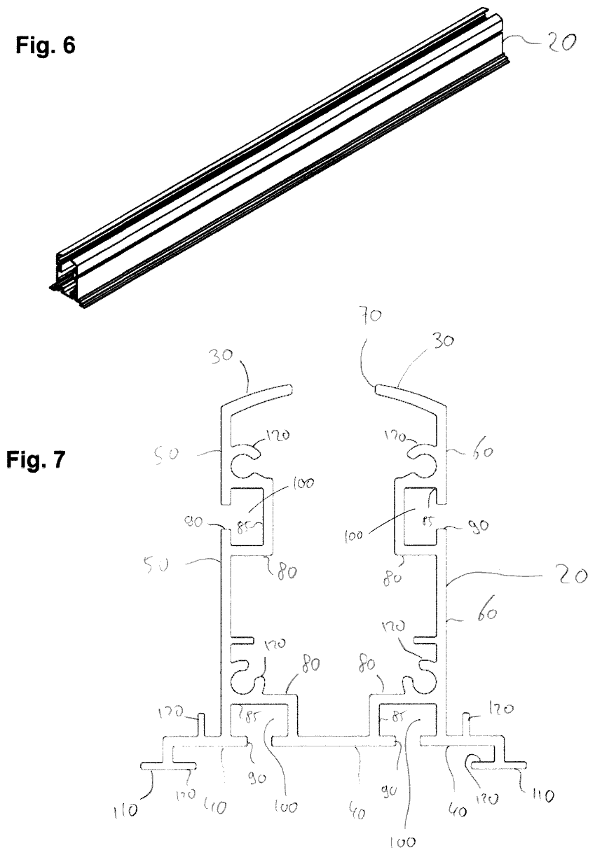

FIG. 1 shows a modular light arrangement 10 suitable for us in a controlled environment agriculture system (not shown). The modular light arrangement 10 may be configured differently for different applications as will be explained. FIGS. 2 and 3 show exploded views of different configurations of the modular light arrangement 10.

The modular light arrangement 10 comprises a structural carrier 20. The structural carrier 20 may be an extruded length of a suitable material such as for example aluminium. The structural carrier 20 may be configured to have a top face 30, a bottom face 40, a first side face 50 and a second side face 60. The bottom face 40, the first side face 50 and the second side face 70 may all substantially run parallel to one another. The structural carrier 20 may have any suitable cross-sectional shape, e.g. substantially square, rectangular, circular, etc.

The top face 30 may be provided with an aperture 70. The aperture 70 may be a through opening as best seen in FIG. 7 or a blind opening (not shown).

The structural carrier 20 may be provided with one or more PCB mounting arrangements 80. The PCB mounting arrangement 80 may include a channel 85. The channel 85 may be generally T-shaped., i.e. having a throat 90 and a cavity 100, with the throat 90 having a smaller cross-sectional diameter than the cavity 100. The channel 85 may be continuous, or a discontinuous group of channels in series.

The bottom face 40 and the first and second side faces 50, 60 may each be provided with at least one channel 85. In one embodiment the first and second side faces 50, 60 are each provided with one channel 85, with the bottom face 40 having two channels 85 running parallel to one another.

The PCB mounting arrangement 80 may include a PCB support ridge 120.

The structural carrier 20 may include at least cover positioning element 110. The cover positioning element 110 may be a projection extending from one of the bottom or side faces 40, 50, 60.

The structural element 20 may be provided with one or more end cap mounting points 130.

The modular light arrangement 10 includes a cover 200. The cover 200 may be an extruded length of a suitable material such as for example plastic. Light may pass through at least a portion of the cover 200. In an embodiment at least one portion of the cover 200 is translucent. The cover 200 may be a single piece component or may include multiple components assembled together to form the cover 200.

The cover 200 may be provided with a longitudinal track 210. The longitudinal track 210 may be generally T-shaped., i.e. having a throat 220 and a cavity 230, with the throat 220 having a smaller cross-sectional diameter than the cavity 230. The longitudinal track 210 may be continuous, or a discontinuous group of longitudinal tracks in series.

The cover 200 may include at least one structural carrier positioning element 240. The structural carrier positioning element 240 may be a projection extending from an internal surface of the cover 200.

The modular light arrangement 10 includes at least one PCB (printed circuit board) 140.

The PCB 140 may be generally strip shaped having a longitudinal axis 145. The PCB 140 may include at least one light emitter 150 capable of providing light for plant development. The light emitter 150 may be a single light element or a cluster of light elements. A suitable light element may for example be a light emitting diode (LED) which for the avoidance of doubt for this context includes quantum dots. In an embodiment the light emitter 150 is a cluster of light emitting diodes (LEDs). The cluster of LEDs may be arranged in any suitable configuration such as for example a linear or matrix configuration. A low power emitter may include 3 light elements such as 3 LEDs. A medium power emitter may include 6 light elements such as 6 LEDs. A high power emitter may include 9 light elements such as 9 LEDs. In an embodiment as shown in exemplary FIG. 14a a low power PCB 140a includes a plurality of low power light emitters 150. In an embodiment as shown in exemplary FIG. 15 a medium power PCB 140b includes a plurality of medium power light emitters 150. In an embodiment as shown in exemplary FIG. 16 a high power PCB 140c includes a plurality of high power light emitters 150. In an embodiment the PCB 140 is an intermediate power PCB (not shown) and may include a combination of low/medium, medium/high, low/high or low/medium/high power emitters.

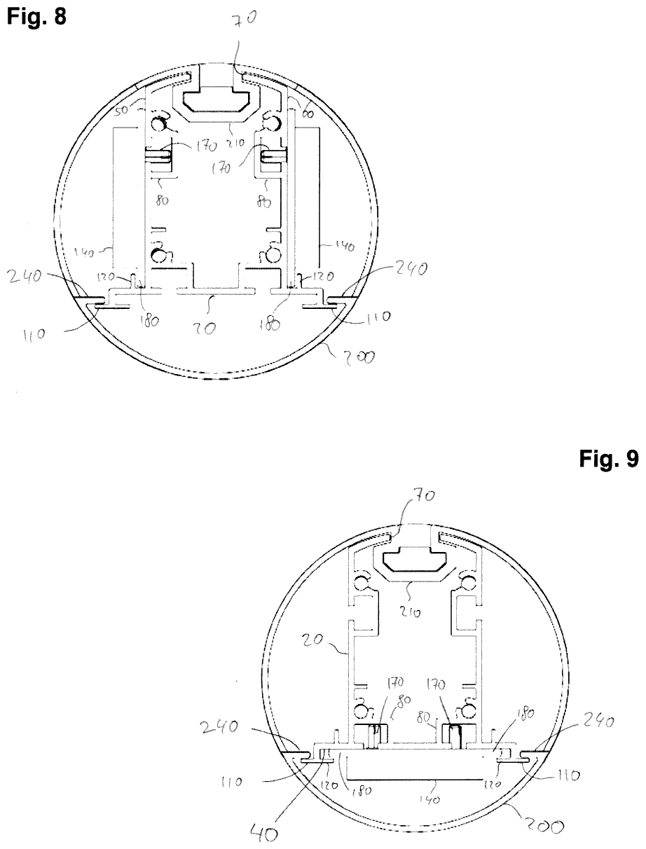

An embodiment of a partially assembled modular light arrangement 10 is shown in FIG. 8. The modular light arrangement 10 shown in FIG. 8 is provided with a PCB 140 mounted to the PCB mounting arrangement 80 of the first side face 50. One or more fasteners 170 may be used to releasably mount the PCB 140 in position. The fasteners 170 may extend through the PCB 140 into the channel 85. The fasteners 170 may flare out into the cavity 100 to retain the fastener in the cavity 80. A lip 180 of the PCB 140 may be held in position by the PCB support ridge 120.

The modular light arrangement 10 shown in FIG. 8 is provided with a PCB 140 mounted to the PCB mounting arrangement 80 of the second side face 60. One or more fasteners 170 may be used to fix the PCB 140 in place. The fasteners 170 may extend through the PCB 140 into the channel 85. The fasteners 170 may flare out into the cavity 100 to retain the fastener in the cavity 80. In one embodiment the fastener 170 is a snap-rivet. A lip 180 of the PCB 140 may be held in position by the PCB support ridge 120. If preferred, only one of the first and second side faces may be provided with a PCB 140.

Another embodiment of a partially assembled modular light arrangement 10 is shown in FIG. 9. The modular light arrangement 10 shown in FIG. 9 is provided with a PCB 140 mounted to the PCB mounting arrangement 80 of the bottom face 40. One or more fasteners 170 may be used to fix the PCB 140 in place. The fasteners 170 may extend through the PCB 140 into the channel(s) 85. The fasteners 170 may flare out into the cavity 100 to retain the fastener in the cavity 80. Opposing lips 180 of the PCB 140 may be held in position by the PCB support ridges 120.

The assembly of the structural carrier 20 and the cover 200 for the embodiments shown in FIGS. 8 and 9 is identical. The cross-sectional diameter of the aperture 70 is smaller than the cross-sectional diameter of the cavity 230, but greater than the cross-sectional diameter of the throat 220. This enables the longitudinal track 210 of the cover 200 to slide into the aperture 70 of the structural carrier thereby slideably coupling the structural carrier 20 to the cover 200. The at least one cover positioning element 110 and the at least one structural carrier positioning elements 240 are in contact or at least in close proximity to one another to assist positioning the cover 200 and the structural carrier relative to one another.

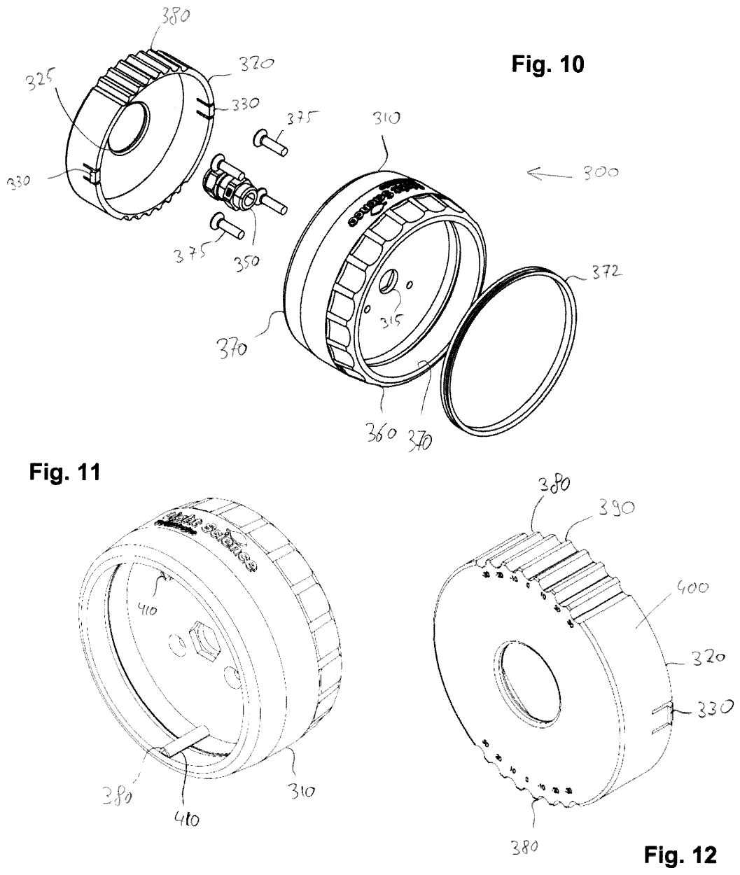

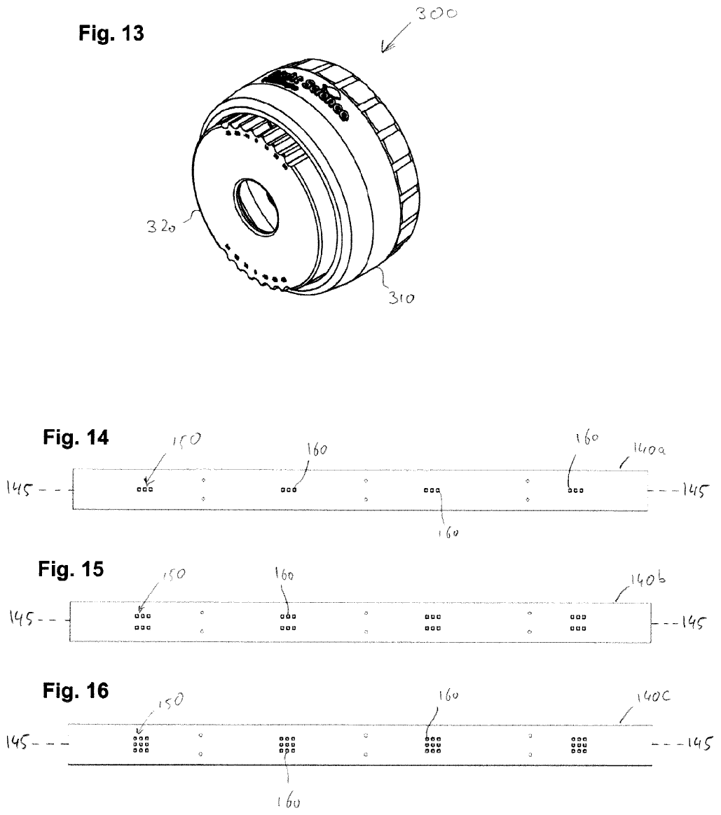

Now turning to FIGS. 10-13, the modular light assembly 10 may include at least one end cap arrangement 300. The end cap arrangement 300 may at least partially close off the modular light assembly 10. The end cap arrangement 300 may be configured to engage with a support structure (not shown) to support modular light assembly 10.

The end cap arrangement 300 may include a first body 310 and a second body 320.

The first and second bodies 310, 320 may be provided with first and second passages 315 and 325 respectively enabling the installation of one or more electrical wires 340 (not shown) and/or connectors 350.

A first end 360 of the first body 300 connects to the structural carrier 20 and/or the cover 200. In an exemplary embodiment as best seen in FIG. 10, the first end 360 may include a first end cavity 370 configured to receive the cover 200. One or more fasteners 375 may be used to screw the first body 300 onto the structural carrier 20 using the end cap mounting points 130. A seal 372 may be positioned between the first body 310 and the cover 200.

A second end 380 of the first body 300 connects to the second body 320. The first and second bodies 310 and 320 may be connected together via a suitable coupling arrangement 330. In one embodiment the coupling arrangement 330 is an interference fit arrangement with resilient snap-fit tabs.

The end cap arrangement 300 may include at least one positioning arrangement 380 configured to enable the modular light arrangement 10 to be positioned in one of a plurality of radial orientations relative to the support structure. In an embodiment the positioning arrangement 380 may include a plurality of radial positioning elements 390 on an external surface 400 of the second body 390. The radial positioning element 390 may for example be a series of grooves or projections. At least one radial locking element 410 on the first 310 body is configured to interlock with at least some of the radial positioning elements 390 enabling relative rotation between the first and second bodies 310, 320 during assembly, but prevent further relative rotation once assembled. The at least one radial locking element 410 may for example be a groove or projection. In an alternative embodiment, the plurality of radial positioning elements 390 may be formed on the first body 310, with the second body 320 being provided with the at least one radial locking element 410.

The modular light assembly 10 may be held in place by a support structure 420 (not shown) engaging the end cap arrangement 300. The support structure 420 may be configured to receive a portion of the second body 320. The support structure 420 may interlock with a portion of the positioning arrangement 380, such that the support structure 420 and the second body 320 are in a rotationally locked engagement.

In an alternative embodiment the modular light assembly 10 may be suspended from a suitable structure such as for example a ceiling by inserting at least one suspension retaining element (not shown) in the longitudinal track 210.

In an alternative embodiment the modular light assembly 10 may be mounted or suspended substantially sideways, upside down or at an intermediate position. Further rotational adjustments may be made using the positioning arrangement 310.

### INDUSTRIAL APPLICABILITY

In use, the modular light arrangement 10 can be assembled in a configuration suitable for its application. The modular light arrangement 10 can also be disassembled for example for repair, overhaul, upgrade or refurbishment.

One application may for example be a CEA environment wherein the modular light arrangement 10 is positioned above plants. This may be referred to as a top-light application. In such situation light may only need to be directed downwards and hence the modular light arrangement 10 may be provided with a PCB 140 on the PCB mounting arrangement 80 of the bottom face 40. No PCBs will be provided on the first and second side faces 50, 60.

A further application may for example be a CEA environment wherein the modular light arrangement 10 is positioned between plants. This may be referred to as an inter-light application. In such situation light may only need to be directed sideways and hence the modular light arrangement 10 may be provided with a PCB 140 on the PCB mounting arrangements 80 of the side face 50 and the side face 60 respectively. No PCB will be provided on the bottom face 40.

A further application may for example be a CEA environment wherein the modular light arrangement 10 is positioned at plant level but adjacent an end row, i.e. plants are present only to one side of the modular light arrangement 10. This may be referred to as an end-light application. In such situation light may only need to be directed sideways of one side of the modular light arrangement 10 and hence the modular light arrangement 10 may be provided with a PCB 140 on the PCB mounting arrangement 80 of one of the side faces 50 and 60. No PCBs will be provided on the bottom face 40 or on the other of the two side faces 50, 60.

A further application may for example be a CEA environment wherein the modular light arrangement 10 is positioned between plants and light may only need to be directed upwards. This may be referred to as a bottom-light application. The modular light arrangement 10 may be provided with a PCB 140 on the PCB mounting arrangements 80 of one of the bottom face 40, the side face 50 and the side face 60. The modular light arrangement 10 may be orientated such that the light directs upwards.

A further application may for example be a CEA environment wherein the modular light arrangement 10 is positioned between plants and light may need to be directed upwards and sideways. This may be referred to as a combi-light application. The modular light arrangement 10 may be provided with a PCB 140 on the PCB mounting arrangements 80 of the bottom face 40 and both side faces 50 and 60. The modular light arrangement 10 may be orientated such that the light directs upwards and sideways.

A further application may for example be a CEA environment wherein the modular light arrangement 10 is positioned between plants and light may need to be directed upwards and sidewards, but to one side only. This may be regarded as an alternative version of the combi-light application. The modular light arrangement 10 may be provided with a PCB 140 on the PCB mounting arrangements 80 of the bottom face 40 and on one of side faces 50 and 60. The modular light arrangement 10 may be orientated such that the light directs upwards and sideways.

The modular light arrangement 10 may be configured as desired with regards to desired beam angles and beam fields. In many applications light will leave the modular light arrangement 10 with a beam angle directed predominantly downwards or predominantly sideways. However, it may be desirable to direct the light at an intermediate angle. The second body 320 may be connected to a support structure 420. By rotating the first and second bodies 310 and 320 relative to one another during assembly and rotationally locking them into place with the positioning arrangement 380, the light can now be directed at a preselected angle such as for example −10, −20, 30, 10, 20, 30 from the standard.

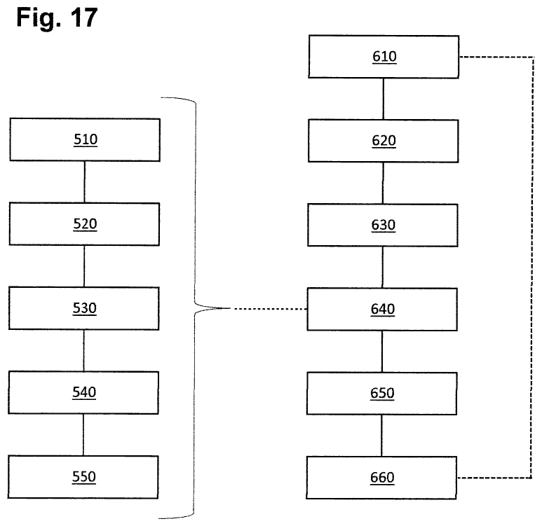

FIG. 17 shows a method of assembling the modular light arrangement 10 that may include the following steps in any suitable order.

Step 510 may be optional and includes determining the application in which the modular light arrangement 10 will be used. This may for example include whether the application is top-light, inter-light, bottom-light, combi-light or end-light (or a combination thereof).

Step 520 may be optional and includes determining the desired output of the modular light arrangement 10. This may for example include selecting at least one of a low, medium or high-powered PCB 140a, 140b, 140c or an appropriate mix thereof.

Step 530 comprises mounting at least one PCB 140 to a least one of the bottom face 40 and the first and second side faces 50, 60. Step 530 may include extending at least one fastener 170 through the PCB 140 into the corresponding cavity 100. A portion of the fastener 170 may flare out in the cavity 100 such that it is too large to exit through the throat 90, thereby locking the PCB to the structural carrier 20. Step 530 may further include positioning the PCB 140 behind the lip 180 for support and/or positioning.

Step 540 comprises assembling the structural carrier 20 and the cover 200 by sliding the structural carrier 20 into the cover 200 (or the cover 200 over the structural carrier 20 which achieves the same effect) and engaging longitudinal track 210 with longitudinal aperture 70 thereby rotationally locking the structural carrier 20 with the cover 200.

Step 550 comprises fitting at least one end cap arrangement 300 to substantially close off the modular light arrangement 10. Step 550 may include using the positioning arrangement 380 to position the modular light arrangement 10 in one of a plurality of radial orientations relative to the support structure. Step 550 may include rotating and rotationally locking the first body 310 and the second body 320 relative to one another using the rotational arrangement 330. Step 550 may further include locking the first body and second body relative to one another using coupling arrangement 330.

After a period of use, the modular light arrangement 10 may be disassembled (i.e. steps 530 to 550 in substantially reverse order) and one or various parts may be exchanged or repaired.

One method of servicing a CEA system without causing too much disruption to the system may comprise the following steps (in any suitable order).

In step 610 a first batch 190a of substantially pre-assembled modular light fittings 10 will be prepared for installation in a CEA system.

In step 620 a second batch 190b of used modular light fittings 10 will be removed from their locations in the CEA system and replaced by the first batch 190a in step 630.

In step 640 the second batch 190b are treated as desired, e.g. disassembled and repaired, upgraded, refurbished or overhauled. Step 640 may for example include some or all of the steps 510-550, in any suitable order). In one embodiment step 640 includes replacing an existing PCB 140 with a new PCB 140. This may for example be a component upgrade or alter the performance of the modular light fitting.

In step 650 a third batch 190c of used modular light fittings 10 will be removed from their locations in the CEA system and replaced by the second batch 190b in step 660.

After step 660 the process may return to step 620 to continue the treatment of further batches in the CEA system. At any time, or once all modular light fittings 10 have been treated in step 640, the remaining batch of modular light fittings 10 may be taken away. They may for example form the first batch 190a in a new step 610 for a second CEA system.

The modularity of the system may offer environmental benefits as a significant portion of the modular light fitting 10 may be reusable. Steps 620 and 660 may also be performed on-site and due to the fact that significant portions of the modular light fittings 10 can be re-used on-site transportation levels are reduced over conventional systems as fewer parts will have to be taken to the CEA site.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A modular light arrangement for a Controlled Environment Agriculture (CEA) system, the modular light arrangement comprising:
a structural carrier having a bottom face with a first PCB mounting arrangement, a first side face with a second PCB mounting arrangement and a second side face with a third PCB mounting arrangement;
a PCB having at least one light emitter, the PCB being removably mounted to one of the bottom face, the first side face and the second side face;
an at least partially translucent cover coupled to the structural carrier.

2. A modular light arrangement according to claim 1, wherein the PCB is removably mounted to the bottom face.

3. A modular light arrangement according to claim 1, wherein the modular light arrangement is provided with an additional PCB, one of the PCBs being removably mounted to the first side face and the other PCB being removably mounted to the second side face.

4. A modular light arrangement according to claim 1 wherein the at least one light emitter includes a plurality of light emitting diodes (LEDs).

5. A modular light arrangement according to claim 1, wherein the at least one light emitter can be configured as a low, medium or high power output light emitter.

6. A modular light arrangement according to claim 1 wherein the structural carrier is an extruded length having at least one longitudinal channel on each of the bottom face, the first side face, and the second side face to aid the connection of any PCBs to the structural carrier.

7. A modular light arrangement according to claim 1 wherein at least one of the bottom face, the first side face, and the second side face is provided with a PCB support ridge to aid the connection of any PCBs to the structural carrier.

8. A modular light arrangement according to claim 1, wherein the structural carrier is provided with a longitudinal aperture and the cover is substantially tubular with a longitudinal track such that during assembly the structural carrier can be inserted into the cover and the longitudinal aperture and the longitudinal track can be slideably coupled to one another.

9. A modular light arrangement according to claim 1, wherein the modular light arrangement is provided with at least one end cap arrangement configured to support the modular light arrangement on a support structure, the end cap arrangement having a plurality of radial positioning elements to enable the modular light arrangement to be positioned in one of a plurality of radial orientations relative to the support structure.

10. A modular light arrangement according to claim 9, wherein the end cap arrangement comprises two bodies, the first body being configured to connect with the support structure, the second body being configured to connect with at least one of the cover and the structural carrier, the first and second bodies being rotationally lockable to one another in one of a plurality of radial orientations of the modular light arrangement relative to the support structure.

11. A method of assembling a modular light arrangement comprising a structural carrier having a bottom face with a first PCB mounting arrangement, a first side face with a second PCB mounting arrangement and a second side face with a third PCB mounting arrangement, the modular light arrangement further comprising at least one PCB having at least one light emitter, the at least one PCB being removably mounted to one of the first, second and third PCB mounting arrangements, and an at least partially translucent cover coupled to the structural carrier, the method comprising the steps of:
mounting the at least one PCB to at least one of the bottom face, the first side face and the second side face of the structural carrier;
longitudinally inserting the structural carrier with the at least one PCB into the cover thereby slideably coupling the structural carrier to the cover;
fitting one or more end caps to the longitudinal ends of the modular light assembly to substantially close off the modular light arrangement.

12. A method according to claim 11, further comprising the steps of:
determining whether the modular light arrangement should be configured as a top-light arrangement, an inter-light arrangement, a bottom-light arrangement, a combi-light arrangement or an end-light arrangement;
mounting the at least one PCB to the bottom face of the structural carrier if the configuration is to be a top-light arrangement; or
mounting the at least one PCB to the first side face and at least one more PCB to the second side face if the configuration is to be an inter-light arrangement; or
mounting the at least one PCB to one of the first and second side faces if the configuration is to be an end-light arrangement, or
mounting the at least one PCB to one of the bottom, first and second side faces if the configuration is to be a bottom-light arrangement; or
mounting the at least one PCB to one of the bottom, first and second side faces and at least one more PCB to another one of the bottom, first and second side faces if the configuration is to be a combi-light arrangement.

13. A method according to claim 11, wherein mounting the at least one PCB to the structural carrier includes extending a removable fastener through the at least one PCB and expanding a portion of the removable fastener into a generally T-shaped channel of the structural carrier thereby locking the PCB onto the structural carrier.

14. A method according to claim 11, wherein the modular light arrangement further includes a positioning arrangement 380 configured to enable the modular light arrangement 10 to be positioned in one of a plurality of radial orientations relative to a support structure, the method further including the steps of:
determining the desired radial orientation of the structural carrier relative to the support structure;
selecting one of the plurality of radial orientations provided by the end cap arrangement that most closely matches the determined desired radial orientation;
rotatably locking the positioning arrangement.

15. A method according to claim 14, wherein the end cap arrangement comprises two bodies, the first body being configured to connect with the support structure, the second body being configured to connect with at least one of the cover and the structural carrier, the first and second bodies being rotationally lockable to one another in one of a plurality of radial orientations relative to one another, the method further comprising the steps off:
determining the desired radial orientation of the structural carrier relative to the support structure;
selecting one of the plurality of radial orientations provided by first and second bodies of the end cap,
connecting and rotatably locking the first and second bodies in the selected radial orientation.

16. A method of servicing a plurality of modular light arrangements according to any of the preceding claims, the method comprising:
providing a first batch of pre-assembled modular light arrangements;
removing a second batch of modular light arrangements from a light installation and replacing them with the first batch;
treating the second batch of modular light arrangements;
removing a third batch of modular light arrangements from a light installation and replacing them with the second batch.

17. A method according to claim 16 wherein treating the modular light arrangements include at least one of the steps of:
a. repairing
b. upgrading
c. overhauling
d. refurbishing
